(19) United States
(12) Patent Application Publication
(10) Pub. No.: US 2012/0207589 A1
(43) Pub. Date: Aug. 16, 2012

(54) DETECTION OF ICE ON AIRFOILS

(75) Inventor: Jack Fridthjof, Viby J (DK)

(73) Assignee: LIWAS APS, Arhus N (DK)

(21) Appl. No.: 13/498,804

(22) PCT Filed: Jul. 8, 2010
(86) PCT No.: PCT/DK10/00106

§ 371 Date: Mar. 28, 2012

(30) Foreign Application Priority Data
Jul. 23, 2009 (DK) PA 2009 00891

(51) Int. Cl. F03D 9/00; G01J 4/00; G01N 21/55

(52) U.S. Cl. 415/121.3; 356/445; 356/369

(57) ABSTRACT

A structure including at least one airfoil, at least one device for detecting surface conditions on a surface of the at least one airfoil, and at least one sensor device, the sensor device including at least one radiation emitter adapted to emit radiation directed towards at least one surface of the airfoil, at least one first detector arranged for receiving a portion of the emitted radiation when reflected from the at least one surface and producing a first output according to an intensity thereof, at least one second detector arranged for receiving a portion of the emitted radiation when reflected from the at least one surface and producing a second output according to an intensity thereof, and control means adapted to receive and evaluate the output from the detectors based on an amount of diffuse reflected and mirror reflected radiation reflected from the at least one surface, and producing an output according thereto.

### TECHNICAL FIELD

The present invention relates to a structure comprising a device for detection of surface conditions of airfoil(s) of the structure, a method of detecting surface conditions on airfoils of a structure, a wind park and a surface property detecting device.

### BRIEF DESCRIPTION OF RELATED ART

Surface conditions such as ice formation on the surface of airfoils such as e.g. wind turbine blades is a well known issue to owners and manufactures of wind turbines, and can cause serious problems to the wind turbine, the wind turbine blades and the surroundings of the wind turbine. When ice is formed on a wind turbine, in particular on the blades, e.g. during standstill of the wind turbine, the turbine can be subjected to serious unintended loads which can cause overload and stress to the wind turbine blades and even to the whole wind turbine and its drive train. The formation of ice may require that the wind turbine is halted and that the operation of the wind turbine cannot be resumed before the ice is removed, e.g. by performing a de-icing of the blades. If operation of a wind turbine is initiated with ice on the blades, the aerodynamics of the blades can be seriously decreased causing a decreased power output from the wind turbine, and ice could be detached from the wind turbine blade and hurled several hundred meters away, causing the risk of damaging other wind turbines (e.g. in a wind park) or other constructions, and injuring humans and animals.

Likewise, surface conditions including especially ice formations on wings of an airplane is a well known problem to the aviation community since ice formation on wings may be a contributing factor to fatal accidents.

U.S. Pat. No. 6,890,152 B1 discloses that, during operation, determination of icy condition could be based on the wind speed, the power code associated with the power generated by the system, the rotor speed, and the temperature and/or humidity of the operating environment. It is also mentioned that during standstill, or just as the rotor starts to turn, a combination of one or more sensors is used for detection of ice, for example a rotor speed sensor, a wind speed sensor observer, a power detector, and a thermal sensor, may be used to detect the presence of ice and monitor the imbalance loads at start-up where the rotor may be purposely held at a low speed for status “check-out” prior to letting the rotor go to full speed. This solution suffers among other things from the disadvantage that several assumptions are necessary to determine if ice is present on the wind turbine blades which makes the method of detecting ice imprecise and unreliable.

U.S. Pat. No. 7,086,834 B2 discloses a method for detecting ice on rotor blades. The method includes monitoring meteorological conditions relating to icing conditions and monitoring physical characteristics of the wind turbine in operation, that vary in accordance with at least one of the mass of one or more rotor blades or a mass imbalance between the rotor blades. The method further includes using the monitored physical characteristics to determine whether a blade mass anomaly exists, and determining whether the monitored meteorological conditions are consistent with blade icing. This solution suffers from the disadvantage that meteorological conditions and physical characteristics varying in accordance with mass of one or more rotor blades could be affected by several other factors which do not have to be synonymous with blade icing.

DE 10 2006 032 387 A1 discloses a wind turbine with an ice detection device. The device comprises a laser emitter arranged at on the surface at the root of a wind turbine blade, to emit a laser beam parallel to the surface of the wind turbine blade, and a detector arranged at the opposite end of the wind turbine blade. The detector detects the laser beam, and if the detected intensity of the laser beam is altered caused by ice refracting the laser beam, the detection device can inform the wind turbine about this. This solution suffers from a number of disadvantages. For example large wind turbine blades bends caused by their length and weight, which results in that the distance from the surface of the blade to the laser beam has to be enlarged, hereby making it hard to detect ice formation. Further this solution only detects ice at one path along the longitudinal axis of the blade. Still further, the need of a sensor at the end of the wind turbine blade is disadvantageous since the installation of the sensor in preinstalled wind turbines is difficult, and since maintenance of the sensor is difficult and expensive.

Further, EP1890128 relates to remote detection of ice on road surfaces.

### BRIEF SUMMARY

The invention provides for an advantageous device and method for detecting surface conditions such as ice formations on airfoils such as wind turbine blades of a wind turbine and/or wings of an aircraft.

The invention relates to a structure comprising at least one airfoil, which structure comprises at least one device for detecting surface conditions on the surface of said at least one airfoil, said device comprising at least one sensor device comprising:

at least one radiation emitter adapted to emit radiation directed towards at least one surface of said airfoil,

at least one first detector arranged for receiving a portion of said emitted radiation when reflected from said at least one surface and producing a first output according to the intensity thereof,

at least one second detector arranged for receiving a portion of said emitted radiation when reflected from said at least one surface and producing a second output according to the intensity thereof, and

control means adapted to receive and evaluate the output from said detectors based on the amount of diffuse reflected and mirror reflected radiation reflected from said at least one surface, and producing an output according thereto.

Hereby an advantageous direct remote detection of surface conditions such as formations of ice on airfoils is achieved. Further, it is achieved that the device is capable of detecting surface conditions on the surface of non-conducting and/or non-metallic materials. Likewise, structural modification of airfoils is avoided due to the remote detection.

The control means may also be referred to as control arrangement.

By the term “structure” is herein understood a wind turbine, the body of an airplane or the like which comprises one or more airfoils. However in other aspects of the invention, the device may be arranged on structures not comprising airfoils and may emit light towards airfoils of other structures.

By the term “airfoil” is herein understood a body designed to provide a desired reaction force when in motion relative to the surrounding air. The airfoil is preferably a wind turbine blade, a wing of an aircraft, but it may also be propellers of a helicopter, propellers of a propelled aircraft or the like.

In a preferred aspect of the invention, at least one of said at least one radiation emitter is a light source.

This is advantageous in that some light sources my emit radiation within an advantageous wavelength.

In a preferred aspect of the invention, the at least one sensor device further comprises a first linear polarization filter arranged in the path of the emitted radiation from said at least one radiation emitter, and a second linear polarization filter arranged in the path of the radiation between said surface and one of the first or second detector.

Thus, it is possible to utilise that polarized light which is mirror reflected preserves its polarization, whereas polarized light which is diffuse reflected largely becomes depolarized, to separate the two types of reflection and achieved advantageous detection of surface conditions e.g. ice formations on an airfoil.

In an aspect of the invention, the direction of polarization of the second filter is perpendicular to the direction of polarization of the first filter.

Hereby, the detector behind second filter will receive the diffuse reflected light, whereas the other detector will receive the mirror reflected light as well as the diffuse reflected light.

In an aspect of the invention, the sensor device further comprises a third polarization filter arranged in the path of the light between said surface and the second detector, wherein said direction of polarization of the third filter is parallel to the direction of polarization of the first and the second filter.

Hereby, one detector behind the third polarization filter receives the mirror reflection plus about half of the diffuse reflection, thereby increasing the signal-to-noise ratio of the detected reflected light.

In an aspect of the invention, the first and second filter are constituted by one linear polarization filter and a beam splitter is arranged between said polarization filter and the radiation emitter for the diversion of a portion of the radiation reflected from the surface into the first detector.

This may be advantageous in that a more space saving device for detecting surface conditions may be achieved.

In an aspect of the invention, the sensor device further comprises a first beam splitter arranged in the path of the radiation from the first linear polarization filter and to the surface for the diversion of a portion of the radiation reflected from the surface into a second path, and a second beam splitter arranged in the second path for the diversion of a portion of the radiation in the second path into the first detector and the transmission of a portion of the radiation in the second path into the second detector.

This may be advantageous in that a further space saving device for detecting surface conditions may be achieved, and the sensitivity to the distance between the sensor device and the surface of the airfoil may be largely decreased.

In an aspect of the invention, the sensor device comprises a reference radiation emitter arranged to emit light substantially in the direction and path of the first radiation emitter, wherein the reference radiation emitter emits radiation of a wavelength on which said polarization filters of the device have substantially no effect, so that the detection of the radiation from the reference radiation emitter by the first and second detector may be used for verification of the function of the system.

Hereby a more secure device is achieved which is especially advantageous at locations which are hard to reach.

In an aspect of the invention, the sensor device comprises a reference radiation emitter for emitting light within an infrared wavelength range of high absorbance by water towards the surface and an absorption detector for receiving the reflection of said emitted light and producing an output to the control means accordingly.

Hereby the reference emitter may be used for spectroscopic measurement of whether liquid water is present on the surface, which in combination with the measurements of diffuse and mirror reflected light may give a precise indication of the surface conditions of the surface of the airfoil.

In an aspect of the invention, the reference radiation emitter is adapted to emit radiation within the wavelength range of 930 nm to 970 nm or within the wavelength range of 1430 nm to 1470 nm.

This is advantageous in that these are wavelength areas where water in particular absorbs radiation.

In an aspect of the invention, the radiation emitter is adapted to emit information carrying radiation, and the device for detecting surface conditions is adapted to evaluate the output from the detectors based on the information contained in the reflected radiation.

This may be advantageous if the device is arranged at a location with a plurality of devices mounted, such as e.g. a wind park, or if the device comprises more than one radiation emitter, to ensure that the detected reflected light is not originating from devices with the purpose of determine the surface properties of surfaces on other wind turbines, or to be capable of distinguish between light emitted from different light emitters. Further information carrying radiation may give the advantage of significantly enhanced signal-to-noise ratio of the detected signal. The information carrying radiation may comprise a series of light pulses, wavelength variation or the like.

In an aspect of the invention, at least said detectors and said at least one radiation emitter are arranged in the same casing.

This is advantageous in that the device is hereby easy to implement on existing structures, and is easier to replace.

In an aspect of the invention, said structure is an aircraft and said airfoil is a wing of the aircraft.

It is advantageous to detect surface conditions on wings of aircrafts since efficiency and safety may hereby be increased. The device may be arranged on the aircraft body, on a tail fin of the aircraft or the like.

In a preferred embodiment of the invention, said structure is a wind turbine and said at least one airfoil is a wind turbine blade of a wind turbine.

Detection of surface conditions such as ice formation on wind turbine blades is a problem presently and is a growing problem e.g. due to the increased size of wind turbines. By remotely detecting ice on wind turbine blades safety and efficiency can is increased. Furthermore, remote detection of ice on wind turbine blades is advantageous in that it may more easy be retrofitted to an existing wind turbine. Also, the blades of wind turbines may have a length of 30-60 meters or even more, and arranging a common ice detection apparatus in the blades would be a cost expensive solution. Especially if service later on is required in that such service would be complicated due to poor accessibility of/in the blades.

Advantageously, the above mentioned wind turbine may in an aspect of the invention comprise wind turbine control means adapted to arrange a wind turbine blade into a predefined position for detection of surface conditions on the surface of said at least one wind turbine blade by means of said at least one device for detecting surface conditions. In such embodiments, the device may be arranged at any appropriate location of the wind turbine. This is advantageous in that an interaction between the position of the detecting device and the wind turbine control means so that enhanced and more precise remote detection of surface conditions may be facilitated.

The wind turbine control means may also be referred to as a wind turbine control arrangement.

In an aspect of the invention, the at least one device is arranged at the tower of the wind turbine.

By arranging the device on the tower of the wind turbine the device is arranged relatively close to the blades.

In an aspect of the invention, wind turbine control means are adapted to yaw the nacelle of a wind turbine into a predefined yaw position for detection of surface conditions on the surface of said at least one wind turbine blade by means of said at least one device for detecting surface conditions.

For the purpose of this application, the term “predefined position” should be understood as a position of a wind turbine blade, nacelle, hub, wind turbine rotor or the like wherein detection of e.g. ice could be performed by the device for detection of surface conditions. The control system of the wind turbine and/or the control means of the device may comprise information of a plurality of predefined positions in which one or more wind turbine blades could be arranged into for detection of surface conditions on the surface of said wind turbine blades. Such predefined positions could be predefined yaw positions, predefined angular positions of the wind turbine rotor (and hereby the blades), predefined blade positions obtainable by means of pitching of the blades and/or the like. A predefined position could e.g. be substantially opposite to the device for detection of surface conditions. As an example, if a device is arranged at the wind turbine tower, the wind turbine blade could be arranged to point downwards and be substantially parallel with the longitudinal axis of the wind turbine tower (obtainable by turning the wind turbine rotor), and arranged to be substantially opposite the device (obtainable by yawing the nacelle). It is to be understood that any predefined position of a blade could be relevant, as long as the device for detection of surface conditions is capable of detecting surface conditions on the surface of one or more wind turbine blades.

In a preferred aspect of the invention, said at least one device for detecting surface conditions is arranged at the nacelle of the wind turbine.

This is advantageous in that yawing the wind turbine nacelle would not influent on the detection of surface conditions on the blades since the device would follow the nacelle. A blade may then in an aspect of the invention be arranged in a predefined position to point upwards (if the device is arranged on the top of the nacelle) and be substantial parallel with the tower.

In an aspect of the invention, wind turbine control means are adapted to turn a wind turbine rotor into a predefined angular position for detection of surface conditions on the wind turbine blade(s) by means of said device for detecting surface conditions.

This is advantageous in that the blade(s) may hereby be arranged at the most advantageous positions for detection of surface conditions.

In an aspect of the invention, said at least one device for detecting surface conditions is arranged at a hub of the wind turbine.

Hereby the device may in an advantageous way detect surface conditions on a blade while the rotor of the wind turbine rotates.

In an aspect of the invention, wind turbine control means are adapted to pitch said at least one wind turbine blade to facilitate that the at least one device for detecting surface conditions can detect conditions on the surface at a plurality of surface areas around the longitudinal axis of said at least one wind turbine blade.

This may be advantageous in that the device may be stationary arranged at one location (it may off cause in an aspect facilitate scanning of a surface as explained later on). By pitching the blade (i.e. rotating the blade around its longitudinal axis) the device may hereby detect surface conditions at surfaces of the blades which are normally not in reach for detection of surface conditions.

For the purpose of this application, by the term “surface area” is meant an area of a surface of an airfoil such as e.g. a small area of the surface of a wind turbine blade or wing of an aircraft. The device for detection of surface conditions may detect surface conditions at a number of locations within a surface area, it could detect ice on substantially the whole surface of a surface area, or the like.

In an aspect of the invention, the device for detecting surface conditions comprises communication means adapted for communication with control means of said wind turbine and/or control means of other wind turbines.

It is advantageous that the device may communicate with the wind turbine on which it is arranged and/or other wind turbines, and these wind turbines hereby may automatically start a de-icing scenario and/or set an alarm if ice is detected, set an alarm if a lubrication leakage is detected (explained in more details later on), or the like.

The communication means may also be referred to as a communication arrangement.

In an aspect of the invention, the communication means are wireless communication means.

Hereby more easy installation of the device for detecting surface conditions may be achieved.

It is understood that in an aspect of the invention, the device may also communicate wired or wirelessly with a control system of an aircraft if the devise is arranged to detect surface conditions on a wing of an airplane.

In an aspect of the invention, the device for detecting surface conditions comprises scanning means for adjusting the direction in which the radiation is emitted towards the surface of the airfoil.

This is advantageous in that the device hereby may detect surface conditions over a larger area of a wind turbine blade or a wing of an aircraft.

In an aspect of the invention, the scanning means comprises a motor driving the adjustment of radiation direction, the motor being controlled by said control means of the device for detecting surface conditions, since a motor is advantageous for adjusting the radiation direction. However, hydraulic, pneumatic scanning means may also in other embodiments be used.

In an aspect of the invention, the at least one radiation emitter is adapted to continuously emit radiation towards the surface of at least one airfoil while the scanning means adjusts the direction in which the radiation is emitted towards the surface, and said detectors are adapted to continuously detect said radiation reflected from the surface, and provide an output accordingly.

This may facilitate a faster detection of surface conditions of larger surface areas of the airfoil. In another aspect, the device may detect surface conditions at one area, then the direction in which the radiation is emitted is adjusted, the device hereafter scans the new area and so on.

In an aspect of the invention, the emitted radiation and the detected reflected radiation will follow substantially the same path.

This is advantageous in that the detectors and the emitter(s) may be arranged closely together.

In an aspect of the invention, the device for detecting surface conditions is adapted to transmit information regarding the surface conditions of at least one surface of an airfoil when the surface conditions is altered to an amount exceeding a predefined threshold for the surface conditions of the airfoil.

This is advantageous in that unnecessary alarms regarding surface conditions may hereby be avoided. The predefined threshold may be determined by determining the characteristic of reflected radiation form a clean surface of an airfoil, and from this characteristic determine the predefined threshold for transmitting information so that when the characteristics of mirror reflected and diffuse reflected light has changed to exceed the predefined threshold, information of surface conditions are transmitted.

In a preferred aspect of the invention, the device for detecting surface conditions is configured for detecting ice on said surface of an airfoil.

Ice on wind turbine blades is a problem since it may alter the aerodynamic profile of the blades/wings. Further, ice on wind turbine blades may be dangerous to the surroundings if it detaches from the wind turbine blades since it may damage other wind turbines (e.g. in a wind park) or other constructions, it may injure humans and animals o the like. By detecting ice on the airfoil it is hereby possible to avoid such situations.

Likewise, protection of aircrafts from in-flight icing as mentioned is a high priority for the aviation community since ice formation on wings can be a contributing factor to fatal accident. Icing on wings of aircrafts may occur when super cooled water particles adhere to an aircraft wing and freeze. When ice builds up on wings of an aircraft, it may simultaneously slow velocity and decrease lift which may send the aircraft into a catastrophic dive. By remotely detecting ice on the wings of an aircraft it is possible to avoid such situations.

In an aspect of the invention, the at least one device for detecting surface conditions comprises de-icing means for de-icing at least a part of said at least one device.

This is advantageous in that the device may hereby operate in more extreme weather conditions. Especially if the device is configured for detecting ice it may be necessary to facilitate de-icing of the device.

The de-icing means may also be referred to as de-icing arrangement.

In an aspect of the invention, the de-icing means are adapted to be activated at least partly on the basis of the output from said device.

This may be advantageous to avoid continuous de-icing of the device when not necessary.

In an aspect of the invention, the device for detecting surface conditions is configured for detecting lubricants such as oil on said surface.

It is advantageous to facilitate detection of lubricants such as oil on airfoils. As an example, bearings such as pitch bearings on wind turbines comprise lubrication. If a bearing has one or more leakages, the lubrication would due to e.g. the centrifugal force be transported over the surface of the wind turbine blade. By detecting this lubricant on the blade, it would be possible to detect defect bearings e.g. even before e.g. a vibration sensor monitoring bearings detects broken bearings.

In an aspect of the invention, the device for detecting surface conditions is configured for detecting foreign particles such as dust particles, soil and/or sand on said surface.

Particles such as dust particles, particles from soil or sand, small particles from a wind turbine due to wear or the like, may stick to the surface of the airfoil causing a disadvantageous aerodynamic profiles. By detecting such particles it is possible to avoid such situations.

In an aspect of the invention, the device for detecting surface conditions is configured for detecting structural changes of the surface.

This is advantageous in that airfoils such as wind turbine blades, wings of an aircraft or the like over time are worn down due to striking particles such as e.g. dust, ice crystals, sand or even birds. This wears down the surface of the airfoils resulting in structural changes of surface of the airfoils. By detection such structural changes it may be possible to monitor the conditions of an airfoil.

The invention also relates to a plurality of structures being wind turbines arranged in a wind park, each wind turbine comprising one or more airfoils being wind turbine blades, wherein at least one of said plurality of wind turbines is a wind turbine comprising at least one device for detecting surface conditions.

It is advantageous to detect surface conditions of blades of wind turbines in a wind park since surface conditions of a blade of one wind turbine may be comparable to surface conditions of other wind turbines in the park, hence one device for detection of surface conditions on an airfoil may be used for determining the surface conditions of a plurality of airfoils. As an example, if ice is detected on one wind turbine blade in a wind park, it is most likely that ice formations on other wind turbines are present or will be present in the near future.

Likewise, in an aspect of the invention where the device detects surface conditions of wings of an airplane, a device detects surface conditions of only one wing, and the detected surface conditions may hereby be considered as the surface conditions of both wings of the aircraft since both wings are exposed to substantially the same conditions. E.g. if ice is detected on one wing, it is almost sure that ice is present on booth wings.

In an aspect of the invention regarding the plurality of structures being wind turbines arranged in a wind park, the at least one wind turbine comprising at least one device for detecting surface conditions comprises means for transmitting information to at least one other wind turbine in said wind park, to inform said at least one other wind turbine about the surface conditions of the wind turbine blades of said wind turbine.

This is advantageous in that surface conditions such as ice formations on one or more blades of a wind turbine may automatically be used to estimate that other neighbouring wind turbines most likely also are exposed too ice formations.

The invention further relates to a surface property detecting device, which device comprises at least one sensor device, which sensor device comprises:

at least one radiation emitter adapted to emit radiation directed towards a surface,

a detector arranged for receiving a portion of said emitted radiation when reflected from said surface and producing an output according to the intensity thereof,

control means adapted to receive and evaluate the output from said detector,

a first linear polarization means arranged in the path of the emitted radiation from said at least one radiation emitter, and

a second linear polarization means arranged in the path of the radiation between said surface and one of the first detector and the second detector,

wherein at least one of said first linear polarization means and said second linear polarization means are adapted for alternating polarization,

wherein said control means is adapted for receiving and evaluating the output from said detector to determine the amount of diffuse reflected and mirror reflected radiation reflected from said surface, and

wherein said control means is adapted for producing an output based on the amount of diffuse reflected and mirror reflected radiation.

Hereby, the surface property detecting device only comprises one detector which may be a space saving and/or cost-efficient solution.

It would be obvious for the skilled person to amend or adapt the device for detecting surface conditions used at the airfoil described above to employ this surface property detecting device instead, i.e. having only one detector instead of two.

It is understood that the above mentioned surface property detecting device comprising polarization means adapted for alternating polarization in an aspect of the invention may be implemented e.g. as in EP18901287 to detect road surface conditions.

In an aspect of the surface property detecting device, the second polarization means is adapted for alternating polarization to alternate between a polarization parallel to the polarization of said first linear polarization filter, and a polarization perpendicular to the polarization of said first linear polarization filter.

Hereby, an advantageous signal-to-noise ratio may be achieved in that the detector when the polarization direction is parallel to the polarization direction of the first filter would receive the mirror reflected light plus only about half of the diffuse reflected light, whereas when the polarization is perpendicular to the polarization direction of the first filter, the detector would receive the diffuse reflected light only.

In an aspect of the surface property detecting device, said polarization means adapted for alternating polarization is adapted to alternate between polarization and no polarization of radiation.

Hereby, the detector will receive the diffuse reflected light (if the polarization means has a polarization direction perpendicular to the polarization means in front of the emitter), whereas when the reflected light is not polarized, the other detector will receive the mirror reflected light as well as the diffuse reflected light.

The polarization means may also be referred to as a polarization arrangement.

In an aspect of the surface property detecting device, the polarization means adapted for alternating polarization is at least one linear polarisation filter adapted for at least partial rotation.

This may be an effective and cost effective way of achieving a polarization means adapted for polarization alternating between a polarization direction parallel to the polarization of the first linear polarization filter, and a polarization perpendicular to the polarization of the first linear polarization filter.

In an aspect of the surface property detecting device, the polarization means adapted for alternating polarization is at least one polarization filter adapted to be alternating lead into the path between the path of the radiation between said surface and said detector, and out of said path.

This may be an effective and cost effective way of achieving a polarization means adapted for alternating polarization between polarization (preferably perpendicular to the polarization direction of the first linear polarization filter) and no polarization of radiation.

Further, the invention relates to a method of detecting surface conditions of a surface of one or more airfoils of a structure, which structure comprises a device for detection of surface conditions, said method of detecting surface conditions comprising the steps of:

emitting radiation towards a surface of the wind turbine blade by means of a radiation emitter,

receiving a portion of the reflected radiation reflected from the surface (6) by means of a first detector and producing an output according to the intensity thereof,

receiving a portion of the reflected radiation reflected from said at least one surface by a second detector and producing an output according to the intensity thereof, and

evaluating the output from said detectors and providing an output based on the amount of diffuse reflected and mirror reflected radiation reflected from said at least one surface.

Hereby, an advantageous method for remote detection of surface conditions on airfoils is achieved.

In an aspect of the method according to the invention, the radiation emitted towards the surface is polarized by means of a first polarization filter and the portion of reflected radiation received by the first detector is polarized by a second polarization filter.

In an aspect of the method according to the invention, the portion of reflected radiation received by the first detector is polarized in a direction perpendicular to the polarization direction of the radiation polarized by means of the first polarization filter.

In an aspect of the method according to the invention, the portion of the radiation reflected from the surface and received by the second detector is polarized by means of a polarization filter in a direction parallel to the polarization direction of the radiation polarized by the first polarization filter.

In an aspect of the method according to the invention said structure is an aircraft and said surface is the surface of a wing of said aircraft.

In a preferred aspect of the method according to the invention, the structure is a wind turbine, and said surface is the surface of a wind turbine blade.

In an aspect of the method according to the invention, the steps are carried out while the wind turbine blade(s) are rotating along with the rotor of said wind turbine.

This is advantageous in that the wind turbine does not have to be shut down to detect the surface conditions on the blades, thereby increasing the overall power output of the wind turbine. Further, it may be possible to facilitate that a wind turbine may produce power over a longer time period since it is possible to detect ice during operation.

In an aspect of the method according to the invention, the wind turbine blade is arranged into a predefined position before the detection of surface conditions is carried out.

In an aspect of the method according to the invention, the steps of the method are carried out repeatedly while the wind turbine blade pitched.

In an aspect of the method according to the invention, the angle with which said radiation is emitted and/or is detected is altered by means of scanning means.

The scanning means may also be referred to as scanning arrangement.

In an aspect of the method according to the invention, the angle with which said radiation is emitted and/or detected is at least partly continuously altered to perform an at least partly continuous scanning of said at least one surface.

In an aspect of the method according to the invention, the method comprises communication between said wind turbine and at least one of said at least one device.

In an aspect of the method according to the invention, the communication at least comprises signals transmitted from at least one of said at least one device to said wind turbine comprising information regarding the surface condition of said at least one wind turbine blade.

In an aspect of the method according to the invention, the communication comprises signals transmitted from said wind turbine to at least one of said at least one device comprising information regarding the position of at least one of said wind turbine blades.

This may be advantageous in that the device may detect surface conditions only when possible/necessary.

In an aspect of the method according to the invention, the communication comprises command signals from at least one of said at least one device to said wind turbine, said command signals comprising information regarding how the position of at least one wind turbine blade should be arranged for detection of surface conditions.

This is advantageous to achieve an effective detection of surface conditions since it may hereby be assured that the device (preferably) has performed a satisfactory detection of surface conditions, e.g. detection without any disruptions, before a blade is rearranged.

In an aspect of the method according to the invention, the wind turbine and/or at least one of said at least one device transmits information regarding the surface conditions of one or more wind turbine blades to neighbouring wind turbines.

This is advantageous in that neighbouring wind turbines may hereby benefit from detected surface conditions of wind turbine blades nearby.

In an aspect of the method according to the invention, the at least one device transmits information regarding the surface conditions of said one or more airfoils when the surface conditions of one or more surfaces are altered to an amount exceeding a predefined threshold for the surface conditions of the one or more airfoils.

This is advantageous in that unnecessary alarms regarding surface conditions may hereby be avoided.

In a preferred aspect of the method according to the invention, the method comprises the step of detecting for ice on said surface by means of the device.

In an aspect of the method according to the invention, the at least one device transmits information regarding the presence of ice on at least one surface when the amount of detected ice and/or surface area exposed to ice exceeds at least one first predefined threshold, and stop transmitting information regarding the presence of ice when the amount of detected ice and/or surface area exposed to ice gets below at least one second predefined threshold.

This may be advantageous in that airfoils may be able to operate with an amount of ice on the surface, and when THRH_2 is reached, ice may be sufficiently removed since de-icing means will perform de-icing until THRH_1 is reached so that de-icing does not have to be performed unnecessarily often. Likewise, alarms may be activated and deactivated based on the predefined thresholds.

In a preferred aspect of the method according to the invention, the method comprises the step of detecting lubricants such as oil on the surface of one or more wind turbine blades.

In a preferred aspect of the method according to the invention, the method comprises the step of detecting foreign particles such as dust particles, soil and/or sand on said surface.

In a preferred aspect of the method according to the invention, the method comprises the step of detecting structural changes of the surface.

### BRIEF DESCRIPTION OF THE DRAWINGS

The invention will be explained in further detail below with reference to the figures of which

FIG. 1 shows a wind turbine seen from the side comprising a device for detection of surface conditions.

FIG. 2 shows a first configuration of a sensor device according to the present invention,

FIG. 3 shows a second configuration of a sensor device according to the present invention,

FIG. 4 shows a third configuration of a sensor device according to the present invention,

FIG. 5 shows a fourth configuration of a sensor device according to the present invention,

FIG. 5a shows a fifth configuration of a sensor device according to the present invention,

FIG. 6 shows an embodiment of the invention where a device for detecting surface conditions is arranged at the hub of a wind turbine,

FIG. 7 shows an embodiment of the invention where a device for detecting surface conditions is arranged at the wind turbine nacelle of a wind turbine,

FIG. 8 shows an embodiment of the invention where a device for detection of surface conditions is arranged at the tower of a wind turbine,

FIG. 9 shows an embodiment of the invention where the device for detection of surface conditions is adapted for altering the angle with which radiation is emitted

FIG. 10 shows an embodiment of a surface condition detection scenario for detecting ice on the blades of a wind turbine for ice formations,

FIG. 11 shows examples of different surface areas of a wind turbine blade, intended for detection of surface conditions,

FIG. 12 shows that the output from a device for detection of surface conditions could be based on thresholds,

FIG. 13 shows a cross sectional view of an aircraft seen from the front where a device for detecting surface conditions detects surface conditions on the wing of an aircraft, and

FIG. 14 shows an aircraft seen from the side where the aircraft comprises a device for detecting surface conditions arranged on the tail fin of the aircraft.

### DETAILED DESCRIPTION

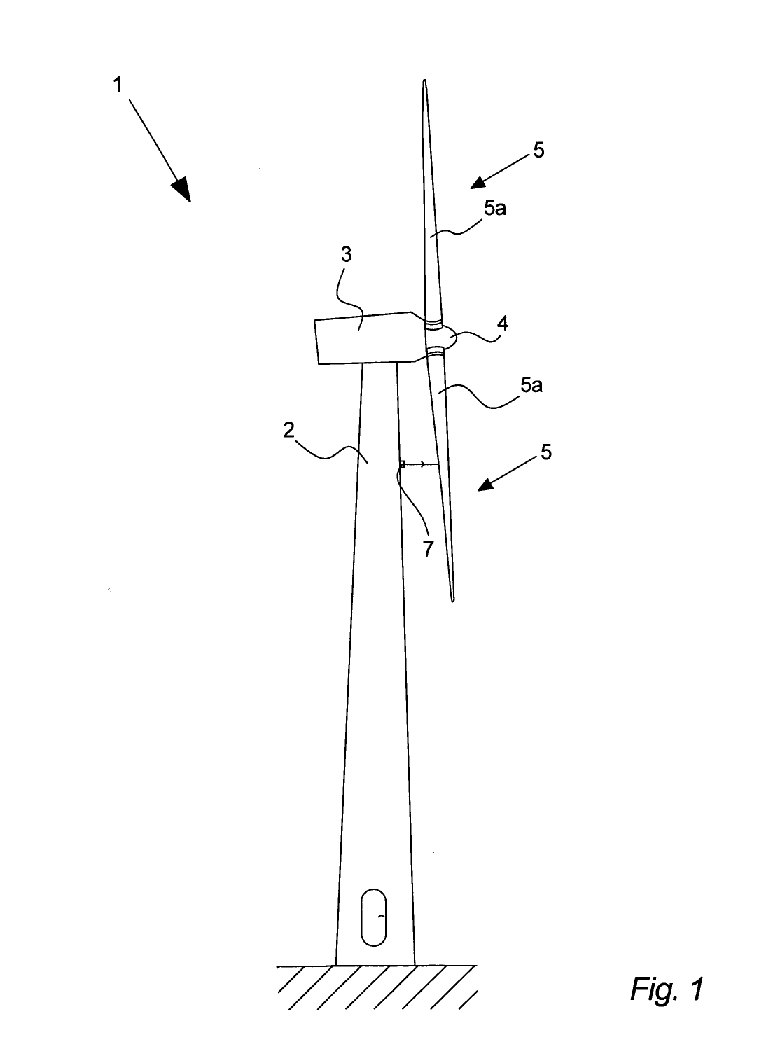

FIG. 1 illustrates one example of a side view of a structure being a modern wind turbine 1 with a tower 2, a wind turbine nacelle 3 positioned on top of the tower 2 and a rotor hub 4. The wind turbine 1 comprises a wind turbine rotor comprising at least one airfoil 5 being a wind turbine blade 5a, preferably two or three wind turbine blades 5a of well known types, such as ones made of a resin reinforced with fibreglass, carbon fibre, a metal, a composition of different materials or the like, each blade being connected to the hub 4, e.g. through a pitch mechanism (not shown) that allows the blade 5a to be turned about a longitudinal axis. A device 7 for detection of surface conditions such as formations of ice is in this embodiment of the invention arranged at the tower 2 of the wind turbine 1. It is understood that the device for detecting surface conditions 7 could also be referred to as “surface condition detecting device 7”, “device 7 for detecting surface conditions” or just “device 7” in the following. It is further noted that as described later on, the device 7 could be arranged at other locations of the wind turbine 1.

In a preferred embodiment of the invention, the device 7 for detecting surface conditions is configured for detecting ice on the surface(s) 6 of airfoils such as wind turbine blades 5a or wings 5b of aircrafts 24 as explained in more details later on. However, the device 7 may in other embodiments be configured for detecting leaked lubricants such as oil on the surface(s) 6, detecting structural changes of the surface(s) 6, detecting foreign particles such as dust particles, soil and/or sand on the surface(s) 6 and/or the like on airfoils 5.

It is to be understood that a device 7 for detection of surface conditions according to the invention could be arranged at a wind turbine 1 for detection of surface conditions on a surface 6 of the wind turbine 1 and that these surface conditions may be used as parameters for monitoring and/or operating/controlling the wind turbine 1. The gained information regarding surface conditions, e.g. that ice formations are detected may also be communicated to a plurality of other neighbouring wind turbines, such as wind turbines in a wind park comprising a plurality of wind turbines, to inform the wind turbines about occurring ice, so that proper precaution may be taken for the operation of these wind turbines, e.g. by conducting de-icing of their wind turbine blades 5a. Likewise one or more devices 7 for detection of surface conditions could be arranged at other locations than on the wind turbine 1 comprising the blades 5a intended for detection of surface conditions, e.g. on other wind turbines 1, on a mast, on the ground or the like.

The device 7 may be powered from an internal power supply system of the wind turbine 1 or aircraft 24 for powering the control systems of the wind turbine 1 or aircraft 24. Alternatively, the device 7 may have an independent power supply with a power source, such as e.g. a photovoltaic module, e.g. combined with power storage such as an electric battery or a capacitor, one or more batteries, it may be power-sources capable of harvesting energy from kinetic energy e.g. occurred due to vibrations of the structure on which the device 7 is arranged or the like.

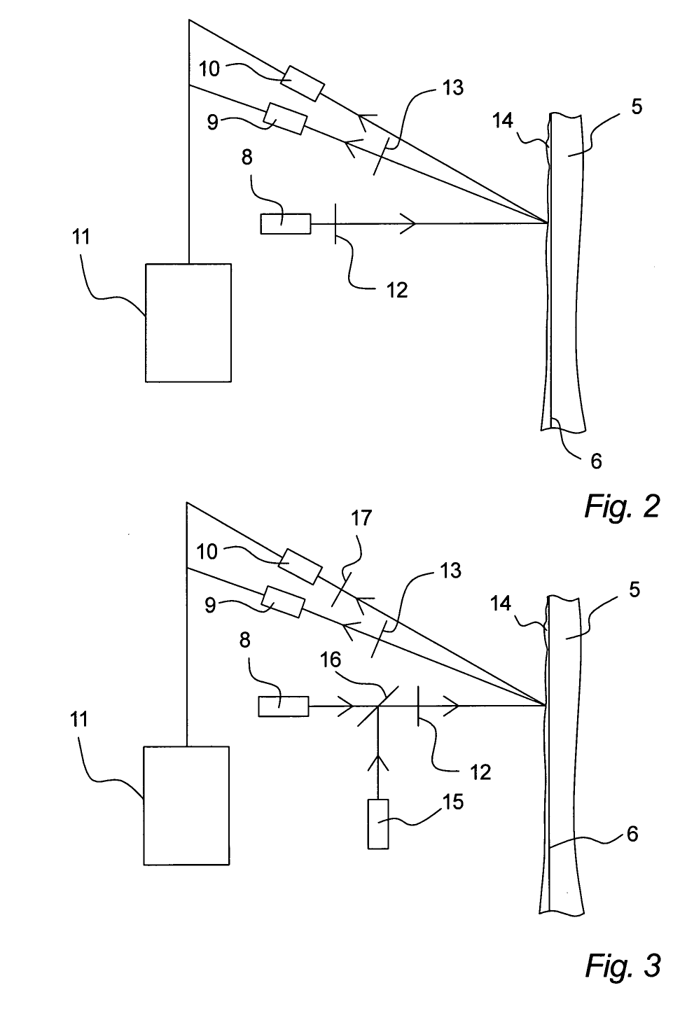

Various embodiments of sensor devices of the device 7 for detection of surface conditions according to the present invention are shown in FIGS. 2-5. They all comprises a radiation emitter 8 that emits radiation towards the surface 6 of an airfoil 5, which could be exposed to surface conditions comprising e.g. occurrence of ice 14, and two detectors 9, 10 for detecting the reflection of the emitted light from the surface 6 and providing an output accordingly to a control unit 11, a linear polarization filter 12 between the radiation emitter 8 and the surface 6, so that the light that meets the surface 6 is polarized, and a linear polarization filter 13 in front of one of the detectors 9, 10, so that the variation in the output from the two detectors 9, 10 will be representative for the variation in mirror reflected light and diffuse reflected light from the surface 6, as the mirror reflected light will preserve its original polarization whereas the diffuse reflected light substantially will become depolarized. Thus, the radiation emitter 8 and the detectors 9, 10 may be situated very closely together and the angle between the incoming and reflected radiation could be within the range of 0° to 15° (both 0° and 15° inclusive). The angles on the figures are exaggerated in order to illustrate the principles more clearly. Thereby, the sensor is quite insensitive to the distance between the sensor and the surface 6 so that the same sensor may be arranged in various locations at the structure 1, 24, and the quality of the output will not be deteriorated by the variations in the distance to the surface 6 of the airfoil(s) 5, during operation or stand still. It is understood that the emitted radiation could be emitted towards the surface 6 in a plurality of different angles as illustrated later on.

The radiation emitter 8 is in a preferred embodiment a light source emitting light such as infrared light or visible light toward the surface 6 of an airfoil, and the radiation emitter 8 can therefore in the following also be referred to as “light source” or “light emitter”, as well as the emitted radiation could also be referred to as “emitted light”, “light” or the like. It is however understood that a microwaves, ultraviolet radiation, or the like in other embodiments of the invention may be used.

The sensor device shown in FIG. 2 has a very simple configuration, in that the light source 8 and the two detectors 9, 10 are arranged side by side so that the light follows a separate path for each of the three. However, due to the small angles between the paths, the two detectors 9, 10 will be subjected to substantially the same intensity of mirror reflected light and diffuse reflected light. A linear polarization filter 13 is arranged in the path of the reflected light to one of the detectors 9,10 and the filter 13 has a direction of polarization perpendicular to the polarization direction of the filter 12 in front of the light source 8, so that the detector 9 will receive the diffuse reflected light and produce an output to the control means 11 accordingly, whereas the other detector 10 will receive the mirror reflected light as well as the diffuse reflected light and produce an output to the control means 11 accordingly. The difference between the two outputs will be a measure of the intensity of the mirror reflected light. The configuration may be improved with another linear polarization filter 17 arranged in front of the other detector 10 and with a polarization direction parallel to the one of the filter 12 in front of the light source 8 as shown in FIG. 3. Thereby, the other detector 10 will receive the mirror reflected light plus only about half of the diffuse reflected light and produce an output to the control means 11 accordingly. Thus, the amplitude variation of the output from the other detector 10 due to the presence of mirror reflection will be enhanced which improves the signal-to-noise ratio of the device 7.

In the embodiment of the sensor device shown in FIG. 3, the configuration has been improved with the presence an extra feature comprising a light source 15, preferably an infrared light source, used as a reference light for verification of the function of the system. This feature may be implemented into each of the shown embodiments of the invention as well as other embodiments thereof.

The infrared reference light source 15 is arranged to emit light substantially in the direction and path of the first light source 8 by means of a beam splitter 16 arranged in that path. The polarization filters 12, 13, 17 have substantially no effect on the infrared light, so that the detection of the light from the reference light source by the first and second detector may be used for verification of the function of the system, correction for temporarily reduced transmittance of the light e.g. due to soiling of lenses or transparent covers, etc. In a preferred embodiment, the infrared reference light source 15 emits light within a wavelength range where water in particular absorbs radiation, in particular around 1450 nm, such as in the range of 1430 nm to 1479 nm, alternatively around 950 nm, such as in the range of 930 nm to 970 nm, and the light source 15 may be used for spectroscopic measurement of whether liquid water is present on the surface, which in combination with the measurements of diffuse and mirror reflected light may give a precise indication of the surface conditions of the airfoil 5. By measuring the variations in intensity of this reference light by means of the detectors 9, 10 while the first light source 8 is turned off, the presence of water on the airfoil 5 may be detected, and the control means 11 may thereby distinguish between mirror reflection from water and from ice, which does not absorb infrared light to the same degree.

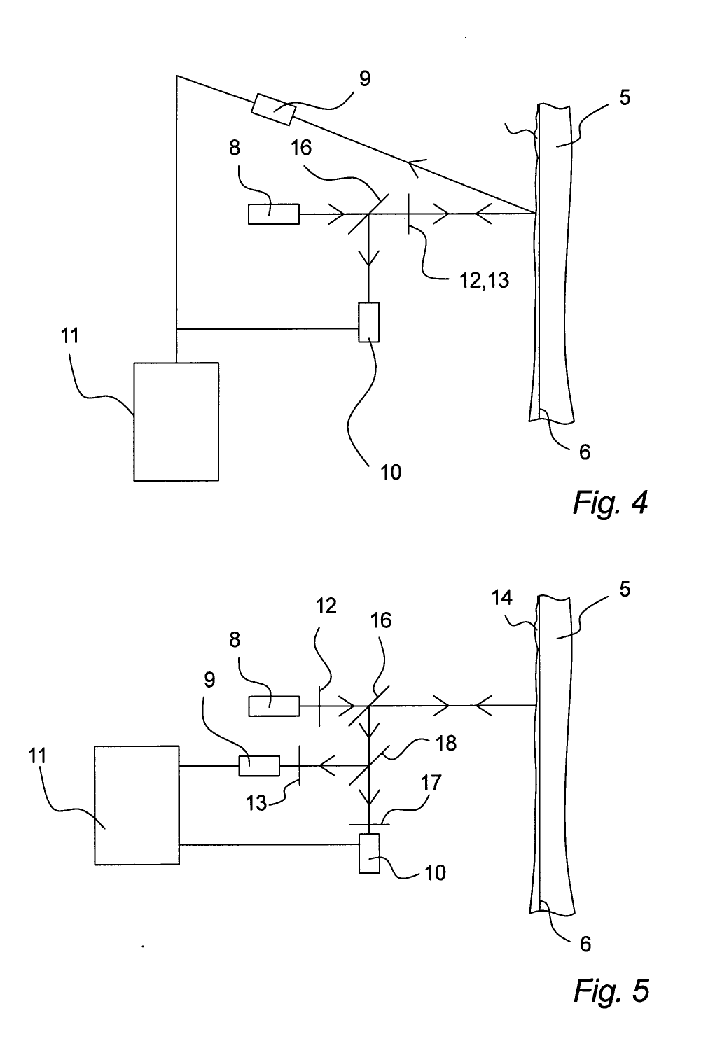

In FIG. 4, yet another configuration of the sensor device is shown, in which only one and the same linear polarization filter 12, 13 is used for the light emitted from the light source 8 towards the surface 6 and the light reflected from the surface towards one of the detectors 10. The light source 8 is directed perpendicularly or in an angle towards the surface 6 and a beam splitter 16 is arranged in the path of the reflected light towards the detector 10, which in this configuration is identical to the path of the light from the light source 8 towards the surface 6.

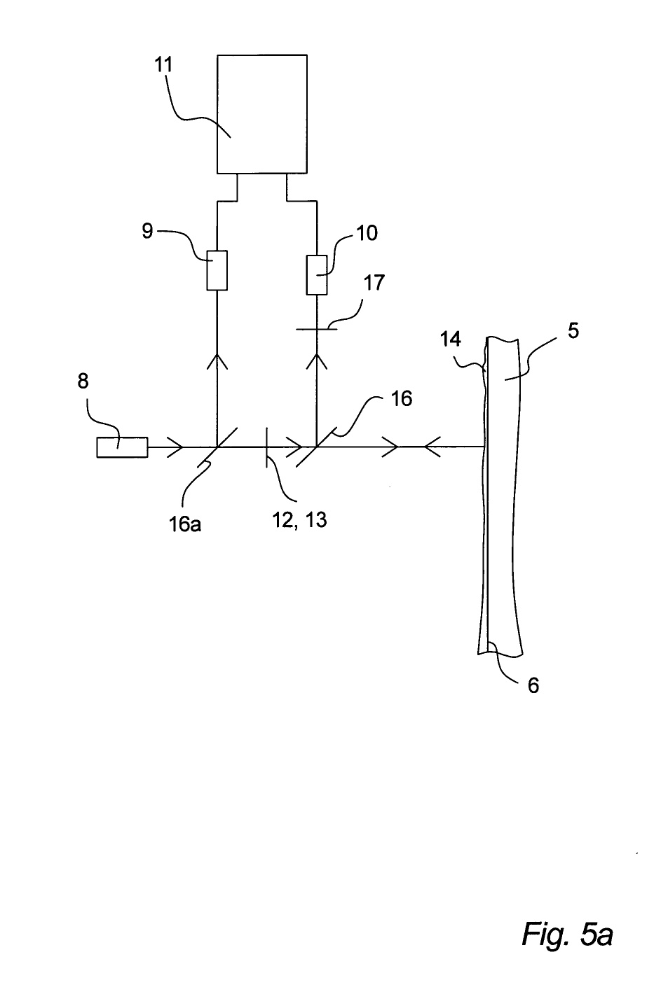

In FIG. 5, another beam splitter 18 is added for dividing the light from the first beam splitter 16 for both detectors 9, 10 so that all light to and from the sensor device may be passed through a small opening or thin tube, which is easy to maintain and clean, and the sensitivity to the distance between the sensor device and the surface 6 may be substantially completely eliminated.

FIG. 5a illustrates another embodiment of a sensor device according to the invention. The light source 8 is directed perpendicularly or in an angle towards the surface 6 and beam splitters 16 and 16a is arranged in the path of the reflected light towards the detector 10, which also in this configuration is identical to the path of the light from the light source 8 towards the surface 6. This embodiment also facilitates that all light to and from the sensor device may be passed through a small opening or thin tube, and at the same time it is possible to spare a polarization filter and obtain an improved signal-to-noise ratio. The polarization filter 17 with a polarization direction perpendicular to the filter 12, 13 improves the signal-to-noise ratio of the device as described earlier, but could be spared.

In a particular embodiment of the present invention (not shown in the figures), the sensor device comprises only one detector for detecting the reflected radiation. Separate polarization means are arranged in front of the detector in the path of the reflected detected radiation, and in front of the light emitter in the path of emitted radiation between the radiation emitter and the surface, respectively (see FIGS. 2-5). In this embodiment at least one of the polarization means either in front of the radiation emitter or in the path of the reflected detected radiation facilitates alternation of the polarization, e.g. shifting between a polarization direction parallel to the polarization of the linear polarization filter in front of the radiation emitter (or in front of the detector) and a polarization direction perpendicular to the polarization direction of the filter in front of the radiation emitter (or in front of the detector) In an alternative embodiment, the alternating polarization means shifts between polarizing the radiation and not polarizing the radiation. The alternating polarisation means may in an embodiment of the invention be a rotating linear polarisation filter, it may be polarization means which is adapted to be alternating led in the path between the reflected detected radiation and the detector, and out of this path, it may be electrically actuated alternating polarization means or any other suitable alternating polarization means. It is to be understood that the feature of alternating polarisation means could likewise be incorporated into any of the embodiments of the invention e.g. shown in FIGS. 2-5a with suitable amendments. The embodiment comprising alternating polarization means and only one detector is not necessarily limited to detection of surface conditions on airfoils 5, but may also be relevant regarding surface property detection on other surfaces such as road surfaces as described in EP1890128, surface property detection on aircrafts as explained later on, on skin such as human skin or the like.

In a preferred embodiment of the invention, the emitted light and the detected reflected light follows substantially the same path. It is generally understood that the device 7 could comprise a plurality of sensor devices illustrated in e.g. FIG. 2-5a, to facilitate fast determination of the surface properties. The sensor devices could be arranged to detect surface conditions on the surface 6 of two or more blades 5a, and/or a plurality of surface areas on the surface 6 of the same airfoil 5 at the same time. Likewise, it is understood that the structure such as a wind turbine 1 or an aircraft 24 may comprise a plurality of devices 7 arranged at various locations to detect surface properties at a plurality of surface areas of airfoils.

The devices 7 may in an embodiment of the invention be adapted to communicate with each other devices 7 e.g. by means of a master-slave communication where the master transmits data from one or more devices 7 for detecting surface conditions to one or more other wind turbines 1, and/or receives and forwards signals from one or more wind turbines 1 to said slaves. Alternatively each device 7 communicates with the wind turbine 1 individually. It is understood that other communication means than master-slave communication may be suitable.

In an embodiment of the invention, the sensor device is adapted for emitting and receiving information carrying radiation for the purpose of improving signal-to-noise ratio of the output from the detector by enabling the elimination of received radiation originating from other sources than the emitter of the sensor device, in particular from emitters of other similar sensor devices arranged on the same or neighbouring structures such as wind turbines. The radiation could be adapted to comprise information by means of modulating the radiation, e.g. by varying the intensity, and/or wavelength of the radiation, or any other method of including information in radiation such as for example light, known to a person skilled in the art. To vary the intensity of the emitted radiation, a shift between emitting radiation with a first intensity and at least one second intensity could be performed. The varying of the intensity could hereby comprise a digital communication characteristic. E.g. a radiation intensity of substantially 100% could be received and interpreted as a “1” and a radiation with lower radiation intensity such as 0%, 25%, 50% or the like could be interpreted as a “0” (or vice versa). The intensity of the radiation could hereby be arranged to follow a predefined pattern such as a bit pattern, a pattern with varying period times, varying duty cycles and/or the like. Likewise could a variation of the wavelength be interpreted in the same way. Varying of the wavelength could be achieved by shifting between two radiation emitters emitting radiation with different wave lengths, by using a dual-wavelength laser, it could be varied by inserting wavelength altering means, such as a Bragg cell, inserted between the radiation emitter and the surface, or the like. By varying the wavelength and/or the intensity as described above, or by means of any other suitable method of including information in radiation known to a person skilled in the art, it is thereby possible to include information in the emitted radiation, which is received by one or more detectors and thereafter interpreted by the control means. The information carrying radiation could comprise identification of the device 7, so the device 7 is capable of determining that the detected reflected light is originating from the correct light emitter. Likewise the information carrying radiation could comprise information regarding the receiving detector/sensor device, hereby making it possible to address light from the radiation emitter of one sensor device to detectors of other sensor devices. It is understood that a plurality of different signal processing methods known to a person skilled in the art could be applied during the transmitting and receiving of light to obtain an even more advantageous and effective surface determination.

In an embodiment of the invention, a characteristic for radiation reflected from a clean surface 6 is established. This may be achieved by transmitting the radiation from the radiation emitter 8 towards the surface 6, and detect the characteristics for mirror reflected and diffuse reflected radiation to determine a characteristic of a clean surface 6. Hereby it may be possible to detect e.g. structural changes of the surface 6, foreign particles on the surface 6, lubricants or the like on the surface 6 by comparing the characteristic of the reflected radiation with the characteristic of a clean surface. Likewise, characteristics for a surface 6 with lubrication, a surface 6 with structural changes, a surface 6 with foreign particles and/or the like may be established, and by comparing such characteristics with a characteristic for radiation reflected from a clean surface 6, it may be possible to distinguish between ice, lubrication, particles and/or structural changes on/of the surface 6. Likewise, if the device 7 determines surface conditions which deviates from a characteristic of a clean surface, but does not correspond to any other established characteristics, it may set an alarm. It is however understood that other suitable methods for detecting lubrication, particles and/or structural changes on/of a surface 6 may be used.

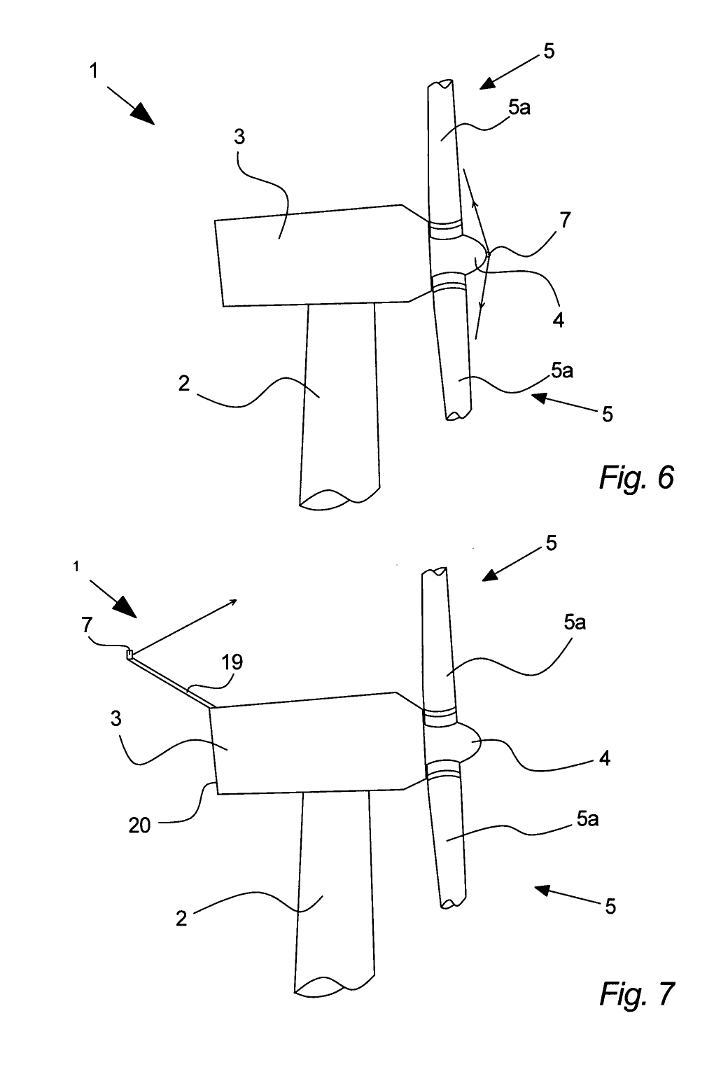

FIG. 6 shows an embodiment of the invention where a device 7 for detection of surface conditions is arranged on the hub 4 of a wind turbine 1. In this embodiment, the device 7 may comprise a sensor device for each blade 5b, e.g. arranged with substantially 120° (if the wind turbine rotor comprises three blades 5b) between the sensors, so the device 7 may perform detection of surface conditions of the blade surface 6 of each blade 5b simultaneously. In another embodiment of the invention the device 7 is adjustable to facilitate surface detection of the blade surface 6 of one or more blades 5b of the wind turbine 1. In yet another embodiment of the invention which is not limited to the embodiment of FIG. 6, at least one device 7 is arranged for each wind turbine blade 5a so the device 7 can perform surface detection of the blade surface 6 of each blade 5b simultaneously.

FIG. 7 illustrates an embodiment of the invention where a device 7 for detection of surface conditions is arranged at the rearmost part of the top of the nacelle 3, to facilitate an advantageous angle of incidence of the emitted light on the blade surface 6, and at the same time facilitate that the device 7 is always correctly arranged if the nacelle is yawed. The device 7 is in FIG. 7 arranged at a support 19 on the nacelle 3, where the support 19 could be an existing support used e.g. for supporting meteorological detectors such as anemometers, thermometers and the like, as well as it could be a support specifically adapted for the device 7. In another embodiment of the invention the device 7 could be arranged substantially on the nacelle cover 20. It is to be understood that the device 7 likewise could be placed on the side of the nacelle 3, on the bottom of the nacelle 3 or the like.

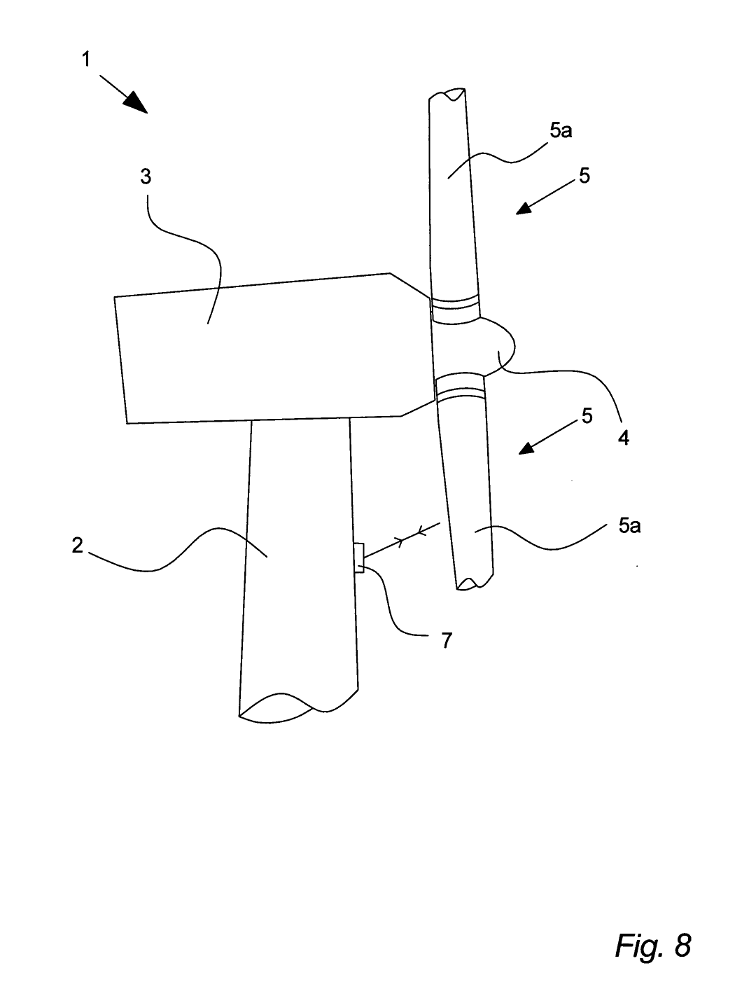

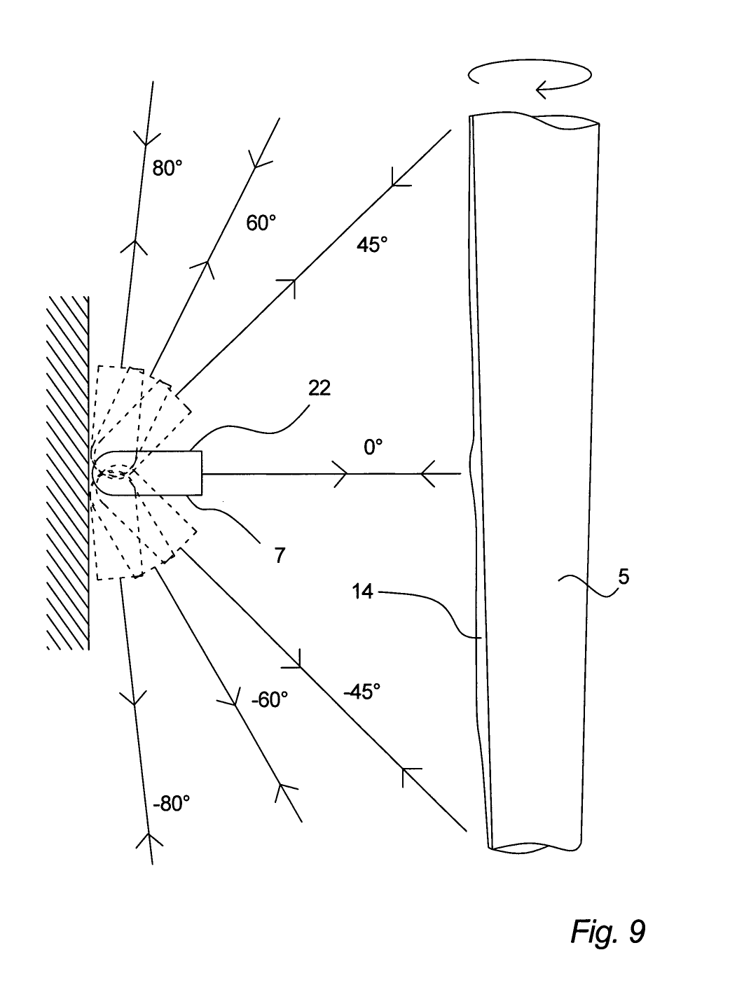

FIG. 8 shows that a device for detection of surface conditions 7 is arranged at/on the tower 2 of the wind turbine 1. When a wind turbine blade 5b is to be checked for surface conditions, the wind turbine 1 (if necessary) yaws the nacelle 3 into position (e.g. opposite to the device 7) for checking the blades 5a for surface conditions, e.g. for checking for ice formation on the blade 5b. This may be achieved e.g. by turn a first blade 5a to point downwards and to be substantial parallel with the wind turbine tower 2, to achieve an advantageous distance from the device 7 to the blade 5a, and to achieve an advantageous position of the wind turbine blade 5b to obtain an easy detection of surface conditions on the surface 6 at a plurality of surface areas of the wind turbine blade 5b. The detection could be performed at various surface areas of a blade surface 6 by altering the angle with which light is emitted or emitted and received in a substantially vertical direction which is substantially in the direction of the longitudinal axis of the blade 5a, as illustrated in FIG. 9 and described in the following.

FIG. 9 shows an embodiment of the invention wherein at least a part of the device 7 comprises scanning means (not illustrated) facilitating adjustment of the angle with which radiation is emitted and/or received. The scanning means may be e.g. a motor driving the adjustment of radiation direction, but it could also be other means capable of altering the radiation direction such as pneumatic actuators or the like. In FIG. 9 (and also illustrated in other figures) at least a part of the device for detection of surface conditions 7 is arranged in a casing 22 comprising at least one transparent part (not illustrated) through which the emitted and reflected light can pass unchanged. In an embodiment of the invention the transparent part could however be a pane comprising polarization means, e.g. substituting one or more polarization filters of the sensor device.

The casing 22, and hereby at least a part of the device 7 could be alterably arranged as illustrated by means of the scanning means, in order to detect surface conditions on the surface 6 of an airfoil at a plurality of locations of the airfoil by altering the angle with which the light is emitted and/or received, hereby facilitating detection of surface conditions at a plurality of surface areas on the airfoil 5.

In FIG. 9 it is illustrated that the device 7 is alterably arranged, but it is understood that only a part of the sensor device of the device 7 could be movable, and e.g. the control means 11, the detectors 9, 10 or the like could be arranged at another locations than in the movable part moved by means of the scanning means.

Likewise, the casing 22 of the device 7 may be movably arranged as illustrated, but the casing 22 may also be stationary i.e. not movably arranged, and the detector(s) and the emitter(s) could then be movably arranged inside the casing by means of the scanning means. Likewise, it is understood that the detector(s) could be arranged in one casing, and the emitter in another casing, or the like.

In an embodiment of the invention, the device for detection of surface conditions 7, or a part of the device 7 could be both horizontally and vertically adjustable by means of the scanning means and/or the device 7 could be movable to another location on the structure (in this case preferably a wind turbine 1), for detecting surface conditions by means of the scanning means which may e.g. comprise rails arranged on the structure 1.

In an embodiment of the invention, the device 7 detects the surface properties at one area of the airfoil surface 6. Then the light source or light sources are turned off and the device 7 is adjusted into the next position by means of the scanning means, the device 7 detects the surface properties of the new area of the airfoil surface 6, then the device 7 is adjusted into the next position etc.

In another embodiment of the invention, the device 7 continuously detects surface properties on the surface 6 of the airfoil 5, by continuously, or at least substantially continuously, emitting light and detecting reflected light from the surface 6, while the angle with which the light is emitted and/or the reflected light is detected, is altered by means of the scanning means.

When ice is formed on an airfoil, there is also a risk that the device 7 is exposed to ice formations, which could prevent the device 7 from detecting surface conditions on the surface 6 of airfoils 5. In an embodiment of the invention, the device 7 therefore comprises de-icing means (not shown) for de-icing the device 7. The de-icing of the device 7 may be performed by means of a plurality of different de-icing means, e.g. by means of an electrically heated and/or at least partly infrared light heated transparent glass pane, e.g. arranged as an at least partly transparent layer on a pane in front of the emitter and the detectors, through which the radiation is emitted and/or received. Other de-icing methods for de-icing the device 7 could be applying (e.g. by spraying) at least a part of the device 7 with a de-icing liquid (e.g. comprising alcohol) which de-ices the device 7, as well as the device 7 could be heated by means of heating means such as a heating element arranged inside the casing 22, the device 7 could be air-tight to avoid occurrence of ice inside the device 7, or the like. It is to be understood that the device 7 could comprise one of the mentioned de-icing means as well as any combination of the mentioned de-icing means, and/or other de-icing means known to a person skilled in the art. It is further to be understood that if the device 7 comprises movable parts, e.g. to facilitate emitting of radiation in a plurality of different angles as explained above, the movable parts may also in an embodiment of the invention be de-iced to ensure that the movable parts is not getting stuck.

In an embodiment of the invention, the device 7 comprises means for cleansing the surface through which the radiation is emitted and/or received, to facilitate that filth is not disturbing the device 7, during detection of e.g. ice, or even preventing the device 7 from detecting surface conditions. The cleansing means may be wipers, flushing means (e.g. the same means as used for de-icing the device 7) or the like.

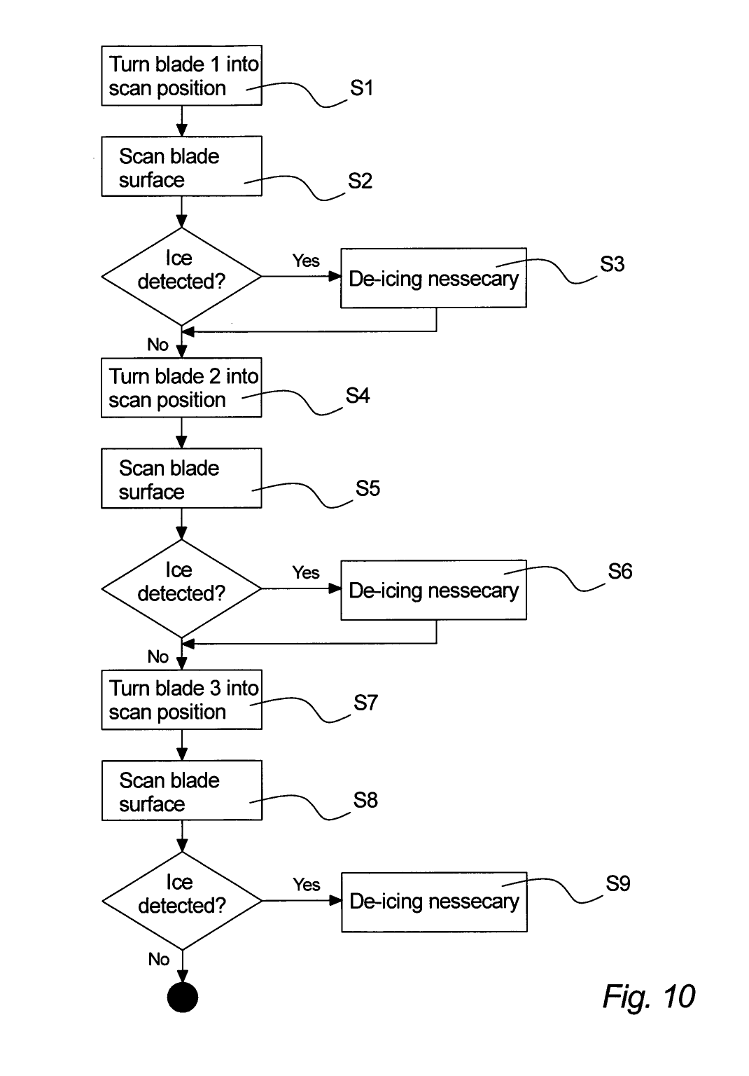

The device 7 may in an embodiment of the invention be adapted to follow a predefined surface condition detection scenario to detect surface properties on airfoils 5. One example of such a predefined surface condition detection scenario is explained in the following and relates to detection of ice 14 formation on all the blades 5a of a wind turbine 1 and is shown in FIG. 10. In the scenario in FIG. 10, detection of ice on the blades 5a are performed on one blade 5a at a time, but it is understood that other embodiments comprising surface condition detection scenarios where more than one blade 5a is checked simultaneously, where a plurality of surface areas are checked simultaneously, where just one blade 5a is checked, e.g. at more surface areas, or the like, is also possible, e.g. by means of more than one sensor devices and/or devices 7.

In step S1, the wind turbine 1 adjusts a blade 5a into a predefined position before detection of ice formation. When the wind turbine blade 5a is adjusted into position, the device 7 in step S2 checks the surface of the blade 5a for ice formations. The wind turbine blade 5a may be checked for ice formation at only one surface area, as well as at a plurality of surface areas in the longitudinal direction of the blade 5a, and it could be turned around its longitudinal axis during a check for ice formation as described later on.

In an embodiment of the invention which is not limited to this particular embodiment, ice detection on airfoils 5 is performed at areas of the surface of the airfoil 5, which experientially is the most exposed to ice formation.

If no ice is detected on the surface 6 of a blade 5a, the wind turbine 1 in step S4 turns the next blade 5a into position for detection of ice. On the other hand, if ice is detected on the surface 6 of a blade 5a, the device 7 in step S3 informs the control system of the wind turbine (not shown) by means of an action about the detected ice formation on the blade or blades 5a, and the wind turbine 1 can then act accordingly, e.g. by activating de-icing means of the blade or blades 5a. Such de-icing could be performed by heating of the blade surface 6 by means of heating means, by causing the blade to vibrate (e.g. by pitching the blade), by means of microwaves, or any other suitable de-icing means know to a person skilled in the art.

The communication between the device 7 and the wind turbine 1 and/or other wind turbines, may be performed by means of wireless communication such as WLAN, Bluetooth, a cell phone network, WIFI, 3G, GPRS or the like, as well as by means of wired connections or any other suitable communication means.

Similar steps as explained in steps S1-S4 of FIG. 10 is performed in steps S5-S9 so that all blades 5a of the wind turbine is scanned for ice formations.

If no ice is detected on the blades 5 of the wind turbine 1, the device 7 may transmit this information to the wind turbine 1, so the wind turbine 1 can go into operation without performing de-icing of the blades 5.

In an embodiment of the invention, the device 7 checks all the blades 5a of the wind turbine 1 for ice, and then provides output to the wind turbine 1 regarding which blades 5a, if any, that need to be de-iced before the wind turbine can go into operation. The wind turbine 1 could perform de-icing only on the blades 5a on which ice is detected, it could perform de-icing on all blades 5a if ice is detected on one blade, it could perform de-icing on a part of a blade or the like.

In an embodiment of the invention which is not restricted to the embodiment of FIG. 10, but could be implemented in any detection of surface conditions on the surface 6 of wind turbine blades 5a, the wind turbine blade 5a is turned around its longitudinal axis during the detection of surface conditions on the blade surface(s) 6 by means of a pitch mechanism, to facilitate detection of surface conditions at different locations of a wind turbine blade 5a. As an example of this embodiment, the device 7 checks the blade surface 6 at a number of surface areas for surface conditions, e.g. at one, two, five, ten, twenty, fifty, hundred or even more surface areas along the longitudinal axis of a blade 5a. Then the blade 5a is turned e.g. 10°, 30°, 45°, 60°, 90°120°, 180° or the like around its longitudinal axis, and the surface 6 is checked for surface conditions again, the blade 5a could then be turned and checked for surface conditions again etc.

It is generally understood that the blades 5a in an embodiment of the invention could be adjusted into a predefined position to be checked for surface conditions, e.g. according to the facilitated surface detection area of the device 7 (in cases where the device 7 is prevented from detecting surface conditions at specific areas of a blade), as well as the device 7 could receive information regarding the position of a wind turbine blade 5a, and then be adjusted (by scanning means) into position for checking the surface 6 of a blade 5a, or the like.

In another embodiment of the invention, the device 7 checks the surface of the wind turbine blades 5a while the turbine blades 5a are rotating along with the rotor of the wind turbine 1 e.g. during start-up of the wind turbine 1, during a forced rotation of the blades 5, when the wind turbine 1 is in operation or the like. The device 7 may check the blades 5a for surface conditions at one point/area, and when the same point/area of the surface 6 of all the wind turbine blades 5a on the wind turbine 1 are checked, the device 7 may be arranged to emit and receive light in an new angle, and then alternating check the surface 6 of the blades 5a at the new point/area, and so on. Hereby it is not necessary to adjust the blades 5a into a predefined, e.g. stationary position for detection of surface conditions, since the check for surface conditions on the blade surfaces is performed while the blades 5a rotate.

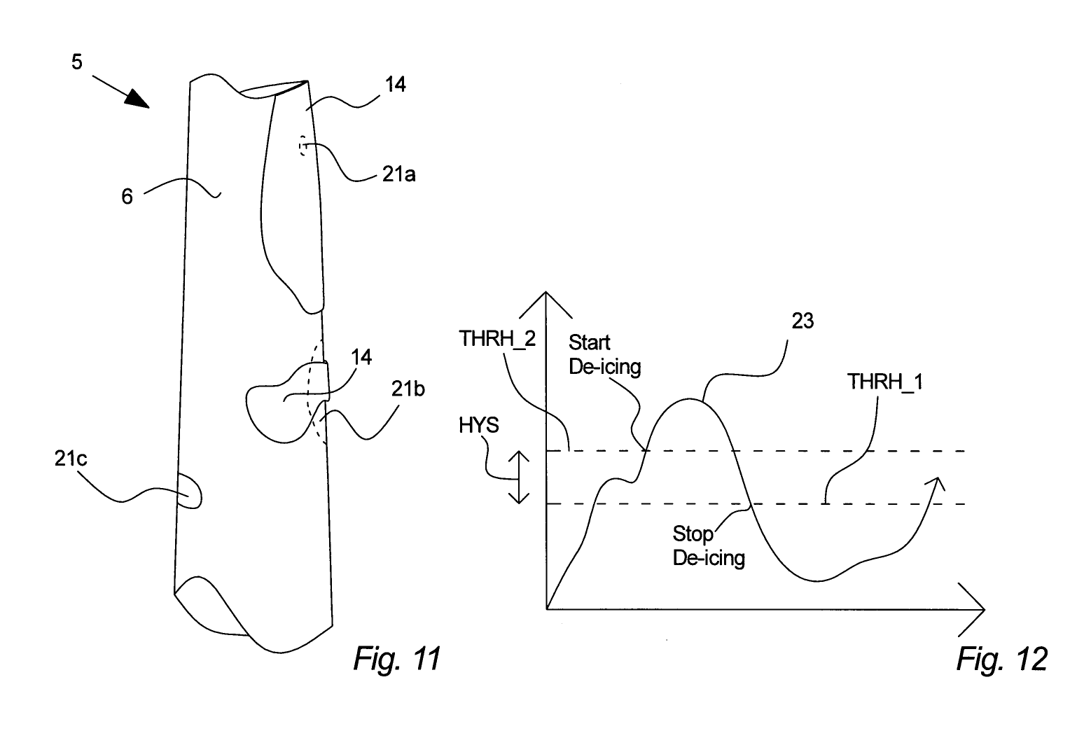

FIG. 11 shows a part of a wind turbine blade 5a. The wind turbine blade 5a comprises a number of surface areas 21a, 21b, 21c intended for detection of surface conditions in this example for ice formations 14. When the device 7 (not illustrated in FIG. 11) scans the surface area 21c for ice 14, it detects no ice, but when the device 7 check the surface areas 21a and/or 21b it will detect the ice 14 and perform an output accordingly. It is to be understood that a surface area intended for detection of occurring ice may e.g. be substantially the size of the cross sectional area of the emitted radiation, as well as surface areas larger than the cross sectional area of the emitted radiation, or the like. Likewise, the device 7 could check a surface area for at a few locations within said surface area, at the whole surface area, at just one location within a surface area or the like.

In an embodiment of the invention, the device 7 transmit a signal to the wind turbine 1, and/or neighbouring wind turbines when e.g. ice is detected and/or surface areas exposed to e.g. ice formation exceeds a predefined threshold.

FIG. 12 shows an embodiment of the invention wherein the device 7 evaluates the detected surface conditions (illustrated by the line 23) at one or more surface areas of one or more airfoils 5. FIG. 12 is in the following explained as an example relating to ice detection on an airfoil 5, but it is understood that it may also be implemented in relation to detecting lubricants, structural changes, particles or the like. When the amount of detected ice, number of surface areas exposed to ice, size of an area exposed to ice or the like exceeds a threshold THRH_2, the device 7 transmits information to the control system of a wind turbine or an aircraft that de-icing is/may be necessary. This information regarding the necessity of de-icing may then be maintained until the amount of detected ice, number of surface areas exposed to ice, size of an area exposed to ice or the like get below the threshold THRH_1 . Even though FIG. 12 shows a hysteresis HYS with two thresholds THRH_1 and THRH_2, it is understood that only one threshold may be used as well as more thresholds comprising a plurality of hysteresis. It is further understood that the calculation regarding when to de-icing is necessary may in an embodiment of the invention be performed by a control system of the wind turbine 1 or aircraft 24.

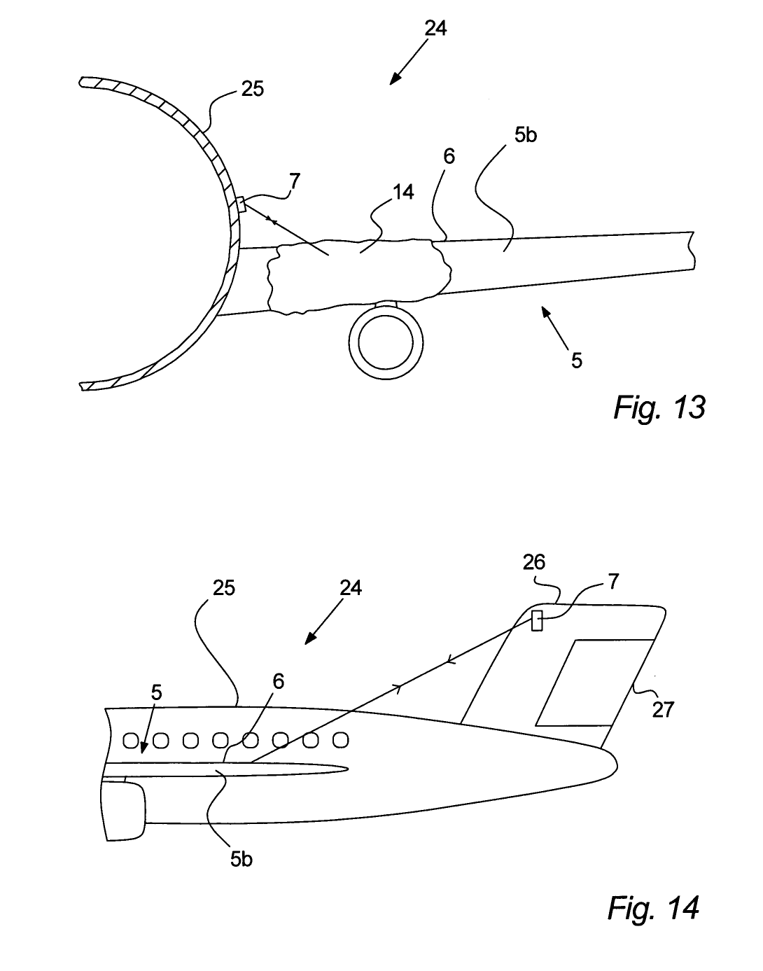

FIGS. 13 and 14 illustrates an embodiment of the invention where the surface condition detection device 7 is arranged to detect surface conditions on wings 5b of an aircraft 24. As illustrated, the device 7 for detecting surface conditions may be arranged on the body 25 of the aircraft 24 above the wing(s) 5b to detect surface conditions such as ice formations on the surface 6 of the wing(s) 5b. It should however be understood that the device (7) for detecting surface conditions may be arranged at any suitable location on the aircraft 24 to detect surface conditions, e.g. on the body 25 of the aircraft 24 in front of the wing(s) 5b, so that the device 7 may more easy detect ice on the front of the wing(s) 5b where ice formations normally occurs first, it may be arranged on a tail fin 26 comprising a rudder 27 as illustrated in FIG. 14, or the like. It is understood that the aircraft 24 may comprise a plurality of devices (7) for detecting surface conditions, e.g. a device 7 for detecting surface condition on each wing 5b, one device 7 for detecting surface conditions on the upper surface of the wing 5b, one for detecting surface conditions on the lower surface wing 5b, one device 7 for detecting surface conditions on the front end of the wing 5b or any combinations thereof.

It should be understood that the invention is not limited to the particular embodiments and examples described above, but may be designed and altered in a multitude of varieties within the scope of the invention. It is likewise to be understood that a multitude of various combinations of the embodiments described above and/or shown in the figures could be incorporated within the scope of the invention.

1. A structure comprising:
at least one airfoil,
at least one device for detecting surface conditions on a surface (6) of said at least one airfoil, and
at least one sensor device, said sensor device comprising:
at least one radiation emitter adapted to emit radiation directed towards at least one surface of said airfoil,
at least one first detector arranged for receiving a portion of said emitted radiation when reflected from said at least one surface and producing a first output according to an intensity thereof,
at least one second detector arranged for receiving a portion of said emitted radiation when reflected from said at least one surface and producing a second output according to an intensity thereof, and
control means adapted to receive and evaluate the output from said detectors based on an amount of diffuse reflected and mirror reflected radiation reflected from said at least one surface, and producing an output according thereto.

2. A structure according to claim 1 wherein at least one of said at least one radiation emitter is a light source.

3. A structure according to claim 1, wherein said at least one sensor device further comprises:
a first linear polarization filter arranged in a path of the emitted radiation from said at least one radiation emitter, and
a second linear polarization filter arranged in a path of the radiation between said surface and one of the first or second detector.

4. A structure according to claim 3 wherein a direction of polarization of the second filter is perpendicular to a direction of polarization of the first filter.

5. A structure according to claim 3 wherein said sensor device further comprises a third polarization filter arranged in the path of the light between said surface and the second detector, wherein said direction of polarization of the third filter is parallel to the direction of polarization of the first and the second filter.

6. A structure according to claim 3, wherein the first and second filter are constituted by one linear polarization filter and a beam splitter is arranged between said polarization filter and the radiation emitter for diversion of a portion of the radiation reflected from the surface into the first detector.

7. A structure according to claim 4 wherein said sensor device further comprises a first beam splitter arranged in the path of the radiation from the first linear polarization filter and to the surface for diversion of a portion of the radiation reflected from the surface into a second path, and a second beam splitter arranged in the second path for diversion of a portion of the radiation in the second path into the first detector and transmission of a portion of the radiation in the second path into the second detector.

8. A structure according to claim 4, wherein said sensor device comprises a reference radiation emitter arranged to emit light substantially in the direction and path of the first radiation emitter, wherein the reference radiation emitter emits radiation of a wavelength on which said polarization filters of the device have substantially no effect, so that the detection of the radiation from the reference radiation emitter by the first and second detector may be used for verification of a function of the system.

9. A structure according to claim 1, wherein said sensor device comprises a reference radiation emitter for emitting light within an infrared wavelength range of high absorbance by water towards the surface and an absorption detector for receiving the reflection of said emitted light and producing an output to the control means accordingly.

10. A structure according to claim 9, wherein said reference radiation emitter is adapted to emit radiation within the wavelength range of 930 nm to 970 nm or within the wavelength range of 1430 nm to 1470 nm.

11. A structure according to claim 1, wherein the- radiation emitter is adapted to emit information carrying radiation, and wherein the device for detecting surface conditions is adapted to evaluate the output from the detectors based on the information contained in the reflected radiation.

12.-13. (canceled)

14. A structure according to claim 1, wherein said structure is a wind turbine and wherein said at least one airfoil is a wind turbine blade of a wind turbine.

15. A structure according to claim 14, comprising wind turbine control means, which- wind turbine control means are adapted to arrange a wind turbine blade into a predefined position for detection of surface conditions on the surface of said at least one wind turbine blade by means of said at least one device for detecting surface conditions.

16. A structure according to claim 14, wherein said at least one device is arranged at a tower of the wind turbine.

17. A structure according to claim 15, wherein the wind turbine control means are adapted to yaw a nacelle of the wind turbine into a predefined yaw position for detection of surface conditions on the surface of said at least one wind turbine blade by means of said at least one device for detecting surface conditions.

18. A structure according to claim 14, wherein said at least one device for detecting surface conditions is arranged at a nacelle of the wind turbine.

19. A structure according to claim 15, wherein the wind turbine control means are adapted to turn a wind turbine rotor into a predefined angular position for detection of surface conditions on the wind turbine blade(s) by means of said device for detecting surface conditions.

20. A structure according to claim 14, wherein said at least one device for detecting surface conditions is arranged at a hub of the wind turbine.

21. A structure according to claim 15, wherein the wind turbine control means are adapted to pitch said at least one wind turbine blade, to facilitate that the at least one device for detecting surface conditions can detect conditions on the surface at a plurality of surface areas around a longitudinal axis of said at least one wind turbine blade.

22.-28. (canceled)

29. A structure according to claim 1, wherein said device for detecting surface conditions is configured for detecting ice on said surface.

30.-65. (canceled)
